(19) United States
(12) Patent Application Publication
(10) Pub. No.: US 2007/0264477 A1
(43) Pub. Date: Nov. 15, 2007

(54) Textured art work and method for creating same

(76) Inventor: Costel Iarca, Chicago, IL (US)

Correspondence Address: MICHAEL A. GUTH, 2-2905 EAST CLIFF DRIVE, SANTA CRUZ, CA, 95062, US

(21) Appl. No.: 11/434,983

(22) Filed: May 15, 2006

(51) Int. Cl. G03G 7/00

(52) U.S. Cl. 428/195.1

(57) ABSTRACT

A method for creating an artwork including adhering layers of latex caulk to a substrate such as a canvas. Paint may be applied over each layer after each layer's application. The layers of caulk may be used in an abstract manner to give texture to the artwork, or may be used in a representational sense to simulate fabric or other materials. An artwork including layers of caulk over a substrate such as canvas. The artwork may be abstract in nature including textured regions utilizing layers of caulk, or be representational including textured regions of caulk strings or other elements.

### BACKGROUND

1. Field of the Invention

This invention relates to artwork, and more specifically to a layered, textured artwork and method for its creation.

2. Description of Related Art

Art materials are normally specific to one medium, such as oil, acrylic, and water color paint for paintings, and clay for three dimensional sculpture and pottery. While each medium works well for its intended use there is usually an inflexibility in attempting to use one of the standard art mediums for mixed media works of art and many of the varied types of experimental works being explored by artists.

U.S. Pat. No. 4,279,674, to Wadden, discloses a process for preparing works of art which includes melting crayon, applying the molten crayon to a backing, and then forming a design on that background. The design is formed using a hand-held heating element. A drawback of this process is that the wax of the crayon is difficult to work with and that the wax is in appropriate for subsequent painting, as one would paint a canvas.

U.S. Pat. No. 5,931,999, to Aisner, discloses a liquid art medium comprising baking soda, corn starch, gesso, and chalk. The liquid art medium is applied to a variety of different surfaces. A distinct drawback of the medium is that it particularly requires chalk, and that is must be made up of a variety of constituents.

What is called for is a method for creating texture in artworks that allows for the adhesion of elements directly to a substrate, such as a canvas, that is also easy to use, and that can be layered over itself as needed by the artist, and can be painted upon as can the substrate.

### SUMMARY

A method for creating an artwork including adhering layers of latex caulk to a substrate such as a canvas. Paint may be applied over each layer after each layer's application. The layers of caulk may be used in an abstract manner to give texture to the artwork, or may be used in a representational sense to simulate fabric or other materials. An artwork including layers of caulk over a substrate such as canvas. The artwork may be abstract in nature including textured regions utilizing layers of caulk, or be representational including textured regions of caulk strings or other elements.

### BRIEF DESCRIPTION OF THE DRAWINGS

FIG. 1 is a photograph of an artwork according to some embodiments of the present invention.

FIG. 2 is a photograph of an artwork illustrating layers of textured elements according to some embodiments of the present invention.

FIG. 3 is a photograph of textured elements on a substrate according to some embodiments of the present invention.

FIG. 4 is another photograph of textured elements on a substrate according to some embodiments of the present invention.

FIG. 5 is a photograph of an artwork illustrating layers of textured elements according to some embodiments of the present invention.

FIG. 6 is an illustrative cross section of a portion of an artwork according to some embodiments of the present invention.

FIG. 7 is a photograph of an artwork according to some embodiments of the present invention.

FIG. 8 is a photograph of an artwork according to some embodiments of the present invention.

FIG. 9 is a photograph of an artwork according to some embodiments of the present invention.

FIG. 10 is a photograph of an artwork according to some embodiments of the present invention.

### DETAILED DESCRIPTION

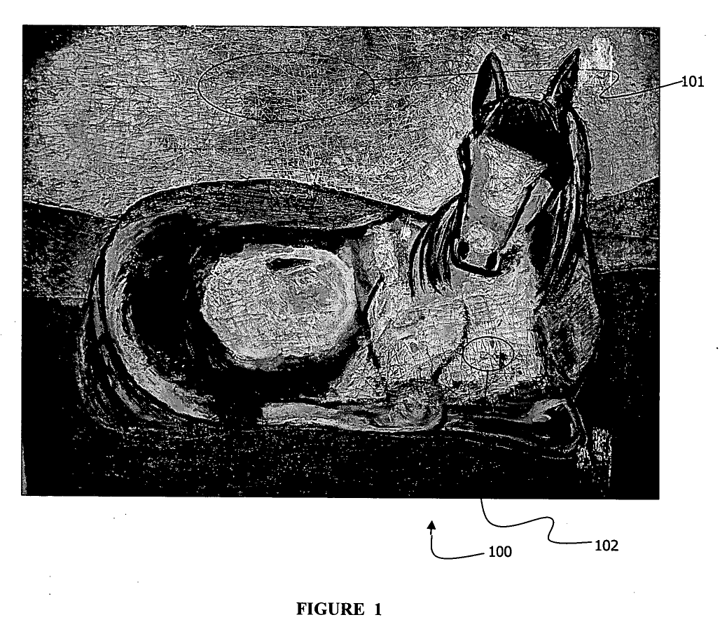

FIG. 1 illustrates an artwork 100 according to some embodiments of the present invention. The artwork 100 has been prepared upon a canvas substrate. The artwork 100 is multi-colored and has been prepared using an art paint. The artwork 100 includes a rich texturing which has been highlighted for discussion purposes in two areas of textured elements 101, 102. The texturing includes layers of textured elements. In some areas, a first layer of textured elements has been applied directly to the canvas substrate. In some areas, the first layer of textured elements has been applied to an area of the canvas which has been previously painted with one or more layers of paint. In some areas, a second layer of textured elements has been applied at least partially overlaying the first layer of textured elements. In some areas additional layers of textured elements have been applied at least partially overlaying the earlier layers of textured elements. In some areas, a layer of textured elements is painted prior to the addition of another layer of textured elements.

The textured elements are created using caulk in some embodiments. The caulk may be a latex caulk. The two primary types of caulking available are latex caulk and silicone caulk. When creating artworks according to embodiments of the present invention, latex caulk is preferred. Latex caulk can be painted similarly to the substrate upon which it is being applied. Latex caulk can be cleaned with soap and water. The two main types of latex caulk are acrylic latex caulk and vinyl latex caulk.

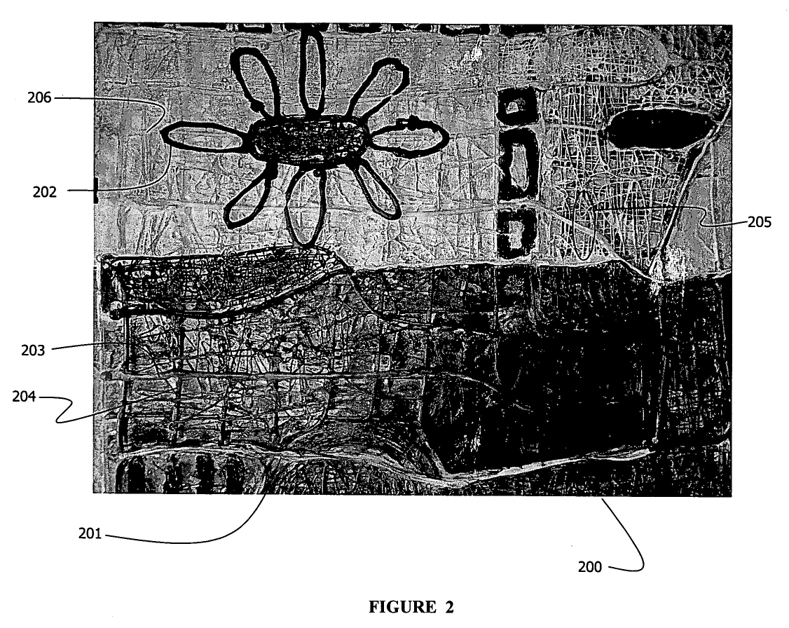

FIG. 2 illustrates an artwork 200 which includes layers of textured elements which have been used to create a rich texture in the artwork. An illustrative area 205 shows how layers of textured elements can be overlayed on top of the substrate. As seen in the illustrative area, textured elements which are predominantly cylindrical in shape have been overlayed.

As also seen in FIG. 2, a textured element 203 partly overlays a textured element 204. The second layer of textured elements includes a plurality of elements 201, 203 and may be overlayed directly on a lower layer of textured elements, or the lower layer of textured elements may be painted prior to the addition of the second layer of textured elements. The use of latex caulk in this fashion gives the distinct advantage of allowing for painting in between application of the textured layers.

In some embodiments, a layer of textured elements may be applied which consists of a mixture 202 of caulk and paint. The mixture used to create is layer of textured elements may be applied over an earlier layer 206 of textured elements. In some embodiments, the lower layer of textured elements may be painted prior to addition of the next layer of textured elements.

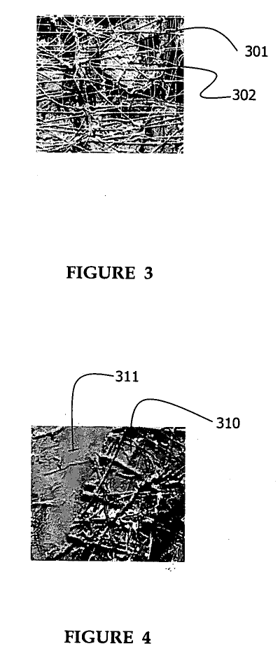

FIG. 3 illustrates a section of an artwork according to some embodiments of the present invention. As seen in the figure, a first textured element 301 is predominantly cylindrical in shape. A second textured element 302 runs in direction close to perpendicular to the first textured element 301. The overlaying of textured elements in this manner allows for the creation of a rich texture in the artwork. Also, the use of the predominantly cylindrical elements in this fashion allows for the representation of fabric in some embodiments. The use of caulk to create these elements allows for creation of textured elements which receive paint in a manner similar to the substrate on which the artwork is being created, and also allows for the use of paints typically used by the artist, such as acrylic. The use of cylindrical elements in this fashion also allows for the representation or wire and other items in the artwork.

FIG. 4 illustrates a section of an artwork according to some embodiments of the present invention. A first region 310 of texture created using layers of textured elements is seen and can be contrasted to a second region 311 which is essentially free from textured elements.

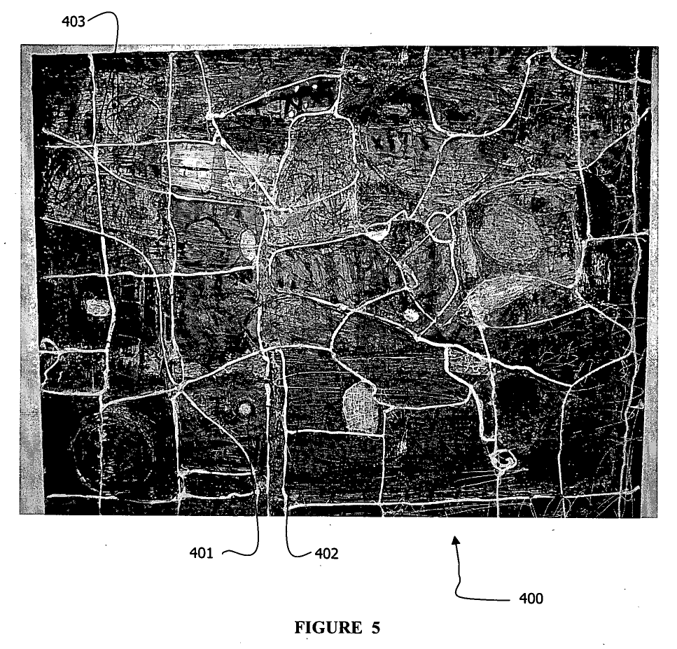

FIG. 5 illustrates an artwork 400 according to some embodiments of the present invention. A first layer of textured elements 402 is seen. The first layer of textured elements 402 has been painted after its application to the artwork. A textured element 401 which is part of a second layer of textured elements is seen overlaying the painted first layer of textured elements. In another region, an unpainted textured element 403 is seen overlaying lower layers of textured elements.

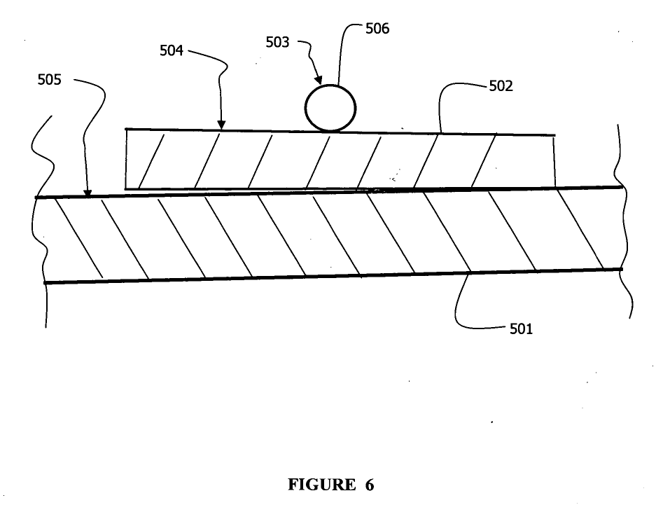

FIG. 6 illustrates an artwork in partial cross-section according to some embodiments of the present invention. A substrate 501 provides a base for the artwork. The substrate is canvas in some embodiments. Wood or other appropriate materials may also be used. Although shown in FIG. 6 as being horizontal, the substrate may ultimately be vertical or in another position. Paint may be applied to the top surface 505 of the substrate 501. A first textured element 502 may be applied to the substrate 501. In some embodiments, the first textured element 502 may be applied directly to the substrate. In some embodiments, the first textured element is applied wholly or in part over paint that has been applied over the substrate.

A second textured element 503 is seen overlaying in part the first textured element 502. In some embodiments, the first textured element 502 may have had paint applied to it prior to the application of the second textured element 506. Paint may also be applied to the surface 503 of the second textured element 506. The first textured element 502 and the second textured element 503 may be predominantly cylindrical in some embodiments.

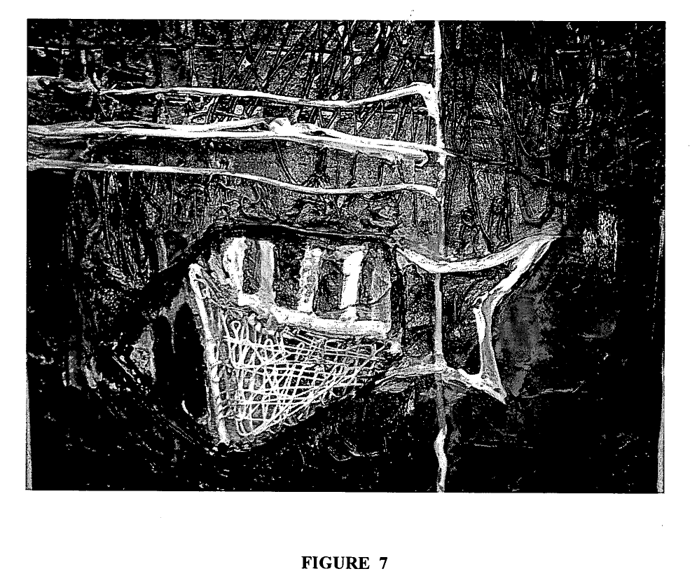

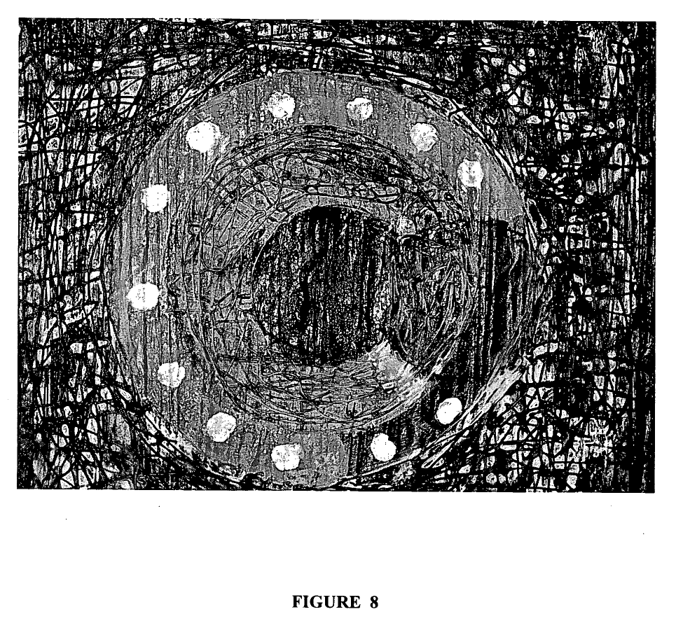

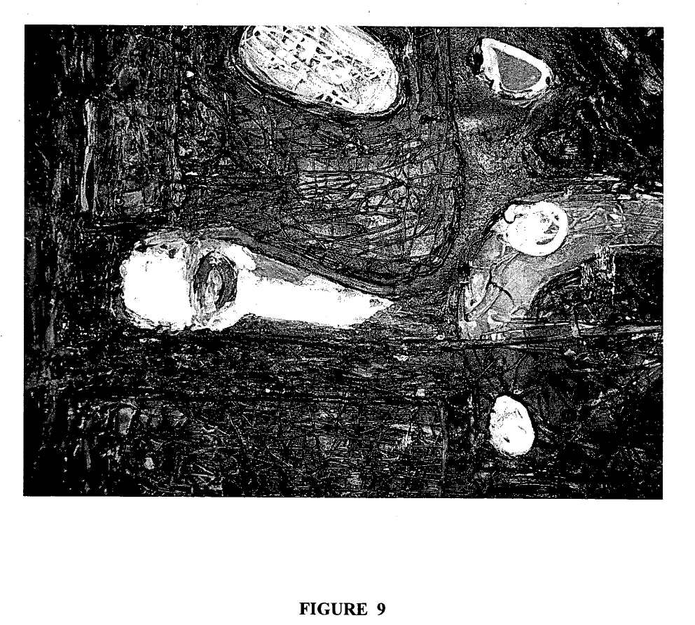

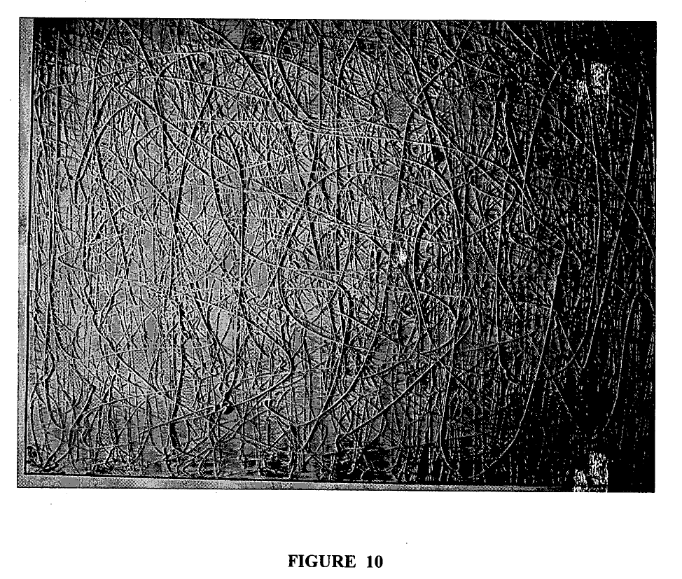

FIGS. 7-10 illustrate examples of artwork created according to embodiments of the present invention. Textured regions are seen in the artworks.

A method for the creation of artwork utilizing substrate, paint, and caulk includes applying a first layer of textured elements onto a substrate. In some embodiments the substrate is canvas. In some embodiments the substrate may have been partially or wholly painted prior to the application of the first layer of textured elements. The first layer of textured elements may be out of latex caulk in some embodiments.

After application of the first layer of textured elements, the textured elements are allowed to dry. In some embodiments, the caulking may be mixed with paint somewhat to present a different texture. In some embodiments, the caulk may be moved and worked with after application according to the artist's desires. In some embodiments, the caulk may be carved with a dull or sharp object to create a variation in surface depth.

After the curing of the caulk of the first layer of textured elements, the work may be painted. All or part of the work as it then exists may be painted with one or more layers of paint, or portions may be left unpainted. A second layer of textured elements may then be applied to the top surface of the work. All or part of this layer may then be covered with one or more layers of paint. Typically, the layer of textured elements will be allowed to cure prior to painting.

A series of repeated layers of textured elements may be added by the artist until the desired outcome is reached. The use or multiple layers of predominantly cylindrical textured elements can be used to create a variety of effects, including the effect of woven material. The textured elements may be of different sizes and thicknesses and may be used to create different effects.

As evident from the above description, a wide variety of embodiments may be configured from the description given herein and additional advantages and modifications will readily occur to those skilled in the art. The invention in its broader aspects is, therefore, not limited to the specific details, representative apparatus and illustrative examples shown and described. Accordingly. departures from such details may be made without departing from the spirit or scope of the applicant's general invention.

I claim:

1. An artwork comprising:
a substrate; and
a first layer of textured elements adhered to said substrate, wherein said first layer of textured elements comprise caulk.

2. The artwork of claim 1 wherein said caulk comprises latex caulk.

3. The artwork of claim 2 further comprising a second layer of textured elements, said second layer of textured elements overlaying at least in part said first layer of textured elements.

4. The artwork of claim 3 further comprising a first layer of paint, said first layer of paint adhered to the surface of said first layer of textured elements, said first layer of paint at least in part underlaying said second layer of textured elements.

5. The artwork of claim 3 further comprising a second layer of paint, said second layer of paint adhered to the surface of said second layer of textured elements.

6. The artwork of claim 4 further comprising a second layer of paint, said second layer of paint adhered to the surface of said second layer of textured elements.

7. The artwork of claim 2 wherein said first layer of textured elements comprises a plurality of predominantly cylindrical elements.

8. The artwork of claim 2 wherein said substrate is includes canvas.

9. The artwork of claim 6 wherein said substrate includes canvas.

10. A method of creating an artwork comprising:
applying a first layer of textured elements to a substrate; and
applying paint to all or part of the surface of the substrate and the first layer of textured elements.

11. The method of claim 10 further comprising applying a second layer of textured elements at least in part overlaying said first layer of textured elements.

12. The of claim 11 wherein said applying a second layer of textured elements includes applying a second layer of textured elements at least in part of a painted portion of the surface of said first layer of textured elements.

13. The method of claim 10 wherein said first layer of textured elements comprise latex caulk.

14. The method of claim 11 wherein said first layer and said second layer of textured elements comprise latex caulk.

15. The method of claim 13 wherein some or all of said first layer of textured elements are predominantly cylindrical.

16. The method of claim 11 wherein some or all of said first layer and said second layer of textured elements are predominantly cylindrical.

17. The method of claim 12 further comprising applying paint over all or part of said second layer of textured elements.

18. A method of creating an artwork comprising:
applying a first layer of textured elements to a substrate;
applying a second layer of textured elements at least in part overlaying said first layer of textured elements; and
applying paint over all or part of said second layer of textured elements.

19. The method of claim 18 wherein said first layer of textured elements comprises latex caulk.

20. The method of claim 18 wherein said second layer of textured elements comprises latex caulk.
